(19) United States
(12) Patent Application Publication
(10) Pub. No.: US 2024/0242083 A1
(43) Pub. Date: Jul. 18, 2024

(54) ANOMALY DETECTION FOR TABULAR DATA WITH INTERNAL CONTRASTIVE LEARNING

(71) Applicant: Ramot at Tel-Aviv University Ltd., Tel-Aviv (IL)

(72) Inventors: Lior WOLF, Tel Aviv (IL); Tom SHENKAR, Tel Aviv (IL)

(73) Assignee: Ramot at Tel-Aviv University Ltd., Tel-Aviv (IL)

(21) Appl. No.: 18/563,892

(22) PCT Filed: May 25, 2022
(86) PCT No.: PCT/IL2022/050552

§ 371 Date: Nov. 23, 2023

Related U.S. Application Data
(60) Provisional application No. 63/192,581, filed on May 25, 2021.

(51) Int. Cl. G06N 3/09; G06N 3/045

(52) U.S. Cl. CPC G06N 3/09; G06N 3/045

(57) ABSTRACT

The disclosure comprises a method to improve machine learning models by cleaning training data using anomaly detection, as well as anomaly detection per se. The method considers the task of finding out-of-class samples in tabular data, where little may be safely assumed about the structure of the data. The method captures the structure of the samples of the single training class, by learning mappings that maximize the mutual information between each sample and a part that is masked out. The mappings are learned by employing a contrastive loss that considers only one sample at a time. Once learned, the disclosure may score a test sample by measuring whether the learned mappings lead to a small contrastive loss using the masked parts of this sample. The experiments show accuracy advantage in comparison to the literature using the same set of hyperparameters as the state of the art results across benchmarks.

### RELATED APPLICATION

This application claims the benefit of priority under 35 USC § 119(e) of U.S. Provisional Patent Application No. 63/192,581 filed on 25 May 2021 the contents of which are incorporated herein by reference in their entirety.

### BACKGROUND

Some embodiments described in the present disclosure relate to a data processing and, more specifically, but not exclusively, to anomaly detection in tabular data.

Anomaly detection is useful for data cleaning and preparation for many machine learning applications, and in particular to the medical, fraud detection, and cyber security fields.

In the one-class classification problem, one learns a model with the goal of identifying whether a test sample belongs to the same distribution from which the training set is sampled. Methods for solving this problem, therefore, define a criterion that is likely to be satisfied for the samples of the training set, while being less likely to hold for samples from other, unseen distributions.

When considering perceptual data, one may rely on the structure of the input. For example, “Deep anomaly detection using geometric transformations” by Golan & El-Yaniv showed in images may be rotated, and the discrimination between the various rotations may be class-dependent and, therefore, indicative of the class.

Various methods have been suggested to model the dependencies between the features, based on the assumption that the dependency structures are class-dependent. For example, one may construct a low-dimensional subspace using PCA and expect out-of-distribution classes to lie outside it.

The main application of one-class classification methods may be anomaly detection, which refers to identifying outliers after observing a set of mostly normal, in distribution, as the opposite of abnormal, out of distribution, samples, as surveyed by Chandola et al. in 2009. A straightforward way to perform this task is to model a distribution based on the training samples and then estimate the likelihood of each test sample. For this purpose, one may employ non-parametric methods, such as Parzen's kernel density estimation, or the COPOD method of Li et al. in “Copula-based outlier detection”, that may be based on an empirical copula model. Parametric methods include Gaussian and Gaussian mixture models. Another way to model probability distributions is through an adversarial approach, as done in the AnoGAN method of “Unsupervised anomaly detection with generative adversarial networks to guide marker discovery” by Schlegl et al., in which the learned generator models the distribution.

An alternative to density estimation approaches relies on regularized classifiers. The classical methods are mostly kernel-based methods, in which the role of the regularization term is to ensure that the fitted model is tight around the observed samples. Many of the first deep learning anomaly detection methods employed such classical one-class methods on top of auto-encoder based representations. More recent methods apply a suitable one-class loss, in order to learn a neural network-based representation in an end-to-end manner. In order to further avoid the problem of representation collapse, the deep robust one-class classification (DROCC) method of Goyal et al. applies virtual adversarial training to create virtual negative samples around the training samples.

Self-supervised learning, in which an unsupervised learning problem may be turned into a discriminative learning problem, was introduced to anomaly detection by Golan & ElYaniv. This method achieved state of the art one-class results for visual datasets by predicting the predefined image transformation that may be applied to an image. Assuming that this classification problem is class-dependent, the membership score may be based on the success of this classifier on a given test image. The recent General openset Anomaly detection (GOAD) technique improved this method, by mapping the data to an embedding space, in which classification between the different transformations may be done by considering the distances to the center of the set of training samples after applying each transformation. The method may be also made suitable for tabular data, in which case random linear projections are used instead of geometric image transformations.

The idea of contrastive learning has emerged in metric learning, where it was used by to train a Siamese network. However, its main application is in unsupervised representation learning. The learned embedding brings associated samples closer together, while pushing away other samples. The framework of noise contrastive estimation casts this type of learning as a form of mutual information maximization. Many of the most recent contrastive learning methods perform unsupervised learning by anchoring an image together with its transformed version, while distancing other images.

Recently, in “Novelty detection via contrastive learning on distributionally shifted instances” by Tack et al the contrastive learning method of “A simple framework for contrastive learning of visual representations” by Chen et al was used for the problem of one-class classification. The obtained score combines the norm of the representation together with the maximal similarity to any sample of the training set, in order to define an anomaly score. The performance may be further enhanced by contrasting two sets of image transformations: those that maintain the same-identity property vs. those that lead to a different-training-identity. As an image-transformation based technique, and especially one that requires two distinct types of such transformations, this disclosure is not directly relevant to tabular data.

### SUMMARY

It is an object of the present disclosure to describe a system and a method for inferring when a record is from a distribution, using a model comprising two neural networks, and feeding each a part of each record, and estimating when the record is from the distribution by applying a threshold on a distance measure between the vector representations generated by each network for each part.

The foregoing and other objects are achieved by the features of the independent claims. Further implementation forms are apparent from the dependent claims, the description and the figures.

According to an aspect of some embodiments of the present invention there is provided a method of training a model for inferring when a record is from a distribution, using a model comprising a first neural network and a second neural network, the method comprising:
receiving a training dataset having:
   a plurality of records comprising a plurality of ground truth records, wherein a record from the plurality of records comprises a first tabular segment, and a second tabular segment;
a plurality of synthetic records each generated by adjusting at least one value in either the first tabular segment or the second tabular segment of a member of the plurality of ground truth records; and
in each of a plurality of iterations processing one of the plurality of records by:
feeding the first tabular segment of the respective record into the first neural network to acquire a first vector representation to a metric space, having a distance measure;
feeding the second tabular segment of the respective record into the second neural network to acquire a second vector representation to the metric space;
when the record is one of the plurality of ground truth records updating at least one neural network parameter of the first neural network or the second neural network so that the distance measure between the first vector representation and the second vector representation decreases; and
when the record is one of the plurality of synthetic records updating at least one neural network parameter of the first neural network or the second neural network so that the distance measure between the first vector representation and the second vector representation increases.

According to an aspect of some embodiments of the present invention there is provided a system for inferring when a record is from a distribution using a model comprising a first neural network and a second neural network, comprising processing circuitry adapted for executing a code for:
receiving a record comprising tabular data;
splitting the record to a first tabular segment and a second tabular segment;
feeding the first tabular segment of the respective record into the first neural network to acquire a first vector representation to a metric space;
feeding the second tabular segment of the respective record into the second neural network to acquire a second vector representation to a metric space; and
estimating when the record is from the distribution by applying a threshold on a distance measure between the first vector representation and the second vector representation.

According to an aspect of some embodiments of the present invention there is provided a method of inferring when a record is from a distribution using a model comprising a first neural network and a second neural network, comprising:
receiving a record comprising tabular data;
splitting the record to a first tabular segment and a second tabular segment;
feeding the first tabular segment of the respective record into the first neural network to acquire a first vector representation to a metric space;
feeding the second tabular segment of the respective record into the second neural network to acquire a second vector representation to a metric space; and
estimating when the record is from the distribution by applying a threshold on a distance measure between the first vector representation and the second vector representation.

According to an aspect of some embodiments of the present invention there is provided a computer readable storage medium having instructions stored thereon, which, when executed by a computer, cause the computer to carry out the computer-implemented method of any one of the aspects of some embodiments of the present invention.

Optionally, further comprising applying at least one permutation to at least one record from the plurality of records.

Optionally, wherein the neural network comprises a plurality of layers and at least one layer of the neural network is followed by batch normalization.

Optionally, wherein the adjusting comprises permuting at least one element from the first tabular segment to the second tabular segment.

Optionally, wherein the first tabular segment is larger than the second tabular segment.

Optionally, wherein the first neural network is substantially a fully connected neural network.

Optionally, wherein the second neural network is substantially a fully connected neural network.

Optionally, wherein the first neural network comprises at least two layers, having a first layer and additional layers and the activation of the first layer differs from the activation of at least one of the additional layers.

Optionally, further comprising applying normalization to at least one element of the tabular data.

Optionally, applied on a plurality of dataset records, and further comprising training an additional network using a method assigning lesser weight to records for which the distance measure exceeded the threshold.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which embodiments. Although methods and materials similar or equivalent to those described herein can be used in the practice or testing of embodiments, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments are herein described, by way of example only, with reference to the accompanying drawings. With specific reference now to the drawings in detail, it is stressed that the particulars shown are by way of example and for purposes of illustrative discussion of embodiments. In this regard, the description taken with the drawings makes apparent to those skilled in the art how embodiments may be practiced.

In the drawings:

FIG. 1 is a schematic illustration of an exemplary system for anomaly detection and machine learning, according to some embodiments of the present disclosure;

FIG. 2 is a schematic illustration of an exemplary distributed system for anomaly detection and machine learning, according to some embodiments of the present disclosure;

FIG. 3 is a flowchart of an exemplary process for training a machine learning model using anomaly detection, according to some embodiments of the present disclosure;

FIG. 4 is a basic flow chart of an exemplary inference process by a machine learning model trained using anomaly detection, according to some embodiments of the present disclosure;

FIG. 5 is a schematic graph representing an exemplary partition of an exemplary vector used for contrastive learning, according to some embodiments of the present disclosure;

FIG. 6 is a table, showing the number of samples, the dimensionality, and the number of samples not from the main class in datasets used for an experiment, according to some embodiments of the present disclosure;

FIG. 7 is a table, showing experiment results, using some embodiments of the present disclosure;

FIG. 8 is an additional table, showing additional experiment results, using some embodiments of the present disclosure;

FIG. 9 is two graphs, showing Dolan-More profile for the ODDS experiments with F1 scores and area under the curve (AUC), according to experiment results, using some embodiments of the present disclosure;

FIG. 10 is a table, showing results of an exemplary ablation experiment using some embodiments of the present disclosure;

FIG. 11 is a set of graphs, showing experiment results of parameter sensitivity and convergence of the loss on random data, according to some embodiments of the present disclosure; and

FIG. 12 is a graph, showing experiment results of effects of the number of repeats on F1 scores, according to some embodiments of the present disclosure.

### DETAILED DESCRIPTION

Some embodiments described in the present disclosure relate to a data processing and, more specifically, but not exclusively, to anomaly detection in tabular data.

This disclosure, considers tabular data, in which there may be no prior information on the structure of the data. If one assumes that no such structure exists, i.e., that the variables are independent, therefore the criterion may be defined by combining the per-feature scores. This, however, is less competitive in the cases in which the features in each sample vector are not independent.

This disclosure is based on a different self-supervised task called masking. In this task, part of the data is held out and is predicted by the rest of the data. This form of self-supervision is used for learning representation in NLP, and in computer vision.

This disclosure, follows the assumption that the way in which a subset of the variables in the feature vector is related to the rest of the variables is class dependent. This subset may be arbitrary. However, for simplicity, considering subsets of consecutive variables. In this manner, for a given record, or an input sample xᵢ∈R^{d}, a set of pairs {(aᵢ^{j}, bᵢ^{j})}ⱼ₌₁^{m}, wherein a^{j}ᵢ is a vector of k consecutive features from xᵢ, also referred to as a second tabular segment, b^{j}ᵢ is the vector all other feature values, also referred to as a first tabular segment, and m=d−k+1 may obtained. All vectors a^{j}ᵢ may have the same length and may vary according to the first coordinate of xᵢ, from which the subsets are collected.

Given a training set, the disclosure may learn a multi-variate mapping F (a first neural network) for the vectors of type b and a mapping G (a second neural network) for vectors of type a such that the mutual information between matching elements (a^{j}ᵢ,b^{j}ᵢ) is maximized, thereby forming a model for inferring when a record is from a distribution. The same networks F,G are learned for all samples i of the training set and for all starting index j. The maximization of the mutual information may be done through contrastive maximization.

This method assumes very little on the structure of the data, which makes it very general. Note that the contrastive learning task that the networks F and G are trained to solve may be easily solved with a very short deterministic program that is class independent, which checks the overlap between bᵢ^{j} and aᵢ^{j′}. However, by employing the disclosed neural method, one learns class-specific models.

This method may be applied on datasets comprising a plurality of dataset records, and may be beneficial for data cleaning, thereby improving the training speed, accuracy, precision, recall, and the likes, of a wide range of machine learning models and neural networks. The cleaning may be applied using a method assigning lesser weight to records for which the distance measure from the estimated distribution exceeded a certain threshold, by omitting these records, or the like.

In an extensive set of experiments, it was shown that by employing this generic method, using a single architecture and the same set of default hyperparameters, are effective in one-class classification of tabular data. The accuracy gap over the existing methods may be sizable and consistent across benchmarks. It is further shown that the method may be insensitive to its hyperparameters.

The disclosure comprises a method of training a model for inferring when a record is from a distribution. The training set is of n in-class samples S={xᵢ}, each is a vector of d dimensions. A score y: R^{d}→R is designed to map records, also referred to as samples from the sample domain to a an area, for example of low value if they are sampled from the underlying distribution from which S is sampled and different areas, for example of high value, otherwise, is a key goal. This mapping may also be referred to as embedding.

The method may have two hyperparameters that specify dimensions: k<d determines the size of the subset of features to consider, and u determines their embedding size. A third hyperparameter τ is the temperature constant of the loss.

The method may first construct a set of m=d+1−k pairs Φ(xᵢ)={(a^{j}ᵢ,b^{j}ᵢ)} from each record, or a training sample xᵢ. This set comprises a plurality of ground truth records. Each pair in this set is obtained by extracting k consecutive variables from xᵢ. Let a^{j}ᵢ, 1≤j≤m be the vector [x^{j}ᵢ, x^{j+1}ᵢ, . . . , xᵢ^{j+k-1}], where superscripts denote elements of the vector xᵢ. It is defined that b^{j}ᵢ=[xᵢ¹, xᵢ², . . . , xᵢ^{j-1}, xᵢ^{j+k}, . . . , xᵢ^{d}] to be the vector of the other d−k elements in xᵢ. This set is an exemplary set comprising a plurality of synthetic records each generated by adjusting at least one value in either the first tabular segment or the second tabular segment of a member of the plurality of ground truth records. Alternative ways of generating adjusted values such as transformations, permutations, and the like are apparent to the person skilled in the art.

Followingly, the disclosed method may learn two mappings F, G that maximize the mutual information between F(bᵢ^{j}) and G(aᵢ^{j}), where (a^{j}ᵢ,b^{j}ᵢ)∈Φ(xᵢ), i=1 . . . n. The same mappings may be learned for all samples and regardless of the index j∈[1,m].

The learning of the model, comprising the two mappings, which may be the first neural network neural and the second neural network, may be trained by a method comprising a plurality of iterations processing one of the plurality of records by feeding the first tabular segment b^{j}ᵢ of the respective record into the first neural network neural network F to acquire a first vector representation to a metric space F^{N}(bᵢ^{j}), having a distance measure, and feeding the second tabular segment a^{j}ᵢ of the respective record into the second neural network G to acquire a second vector representation to the metric space G(a^{j}ᵢ), having a distance measure.

Following the training, a test sample or a data record may be split to a vector pair in the same manner, and the distance measure between the parts may be used to determine the confidence level of the vector belonging to the distribution.

Inferencing using the disclosed model, comprising a first neural network and a second neural network, may be performed by receiving a record comprising tabular data, splitting the record to a first tabular segment b and a second tabular segment a, feeding the first tabular segment of the respective record into the first neural network I to acquire a first vector representation to a metric space feeding the second tabular segment of the respective record into the second neural network G to acquire a second vector representation to a metric space, and estimating when the record is from the distribution by applying a threshold on a distance measure between the first vector representation and the second vector representation.

A one-class classification method for generic tabular data is disclosed. The method assumes that it is possible to identify missing features based on the rest and employs a contrastive loss for learning without any other auxiliary loss. In an extensive set of experiments, the method presents a significant gap over the existing anomaly detection methods. The method requires no tuning between the different datasets and is stable with respect to its hyperparameters, however such adjustments may be made by some embodiments.

It should be noted that while some examples disclosed in details are applied on a vector, it would be obvious to the person skilled in the art to extend the disclosed method to matrices, tensors, vectors comprising vectors and/or matrices, and the likes. Similarly, it would be obvious to the person skilled in the art to use a triplet or a larger set of vector parts rather than a pair, and the likes.

Before explaining at least one embodiment in detail, it is to be understood that embodiments are not necessarily limited in its application to the details of construction and the arrangement of the components and/or methods set forth in the following description and/or illustrated in the drawings and/or the Examples. Implementations described herein are capable of other embodiments or of being practiced or carried out in various ways.

Embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments.

Aspects of embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

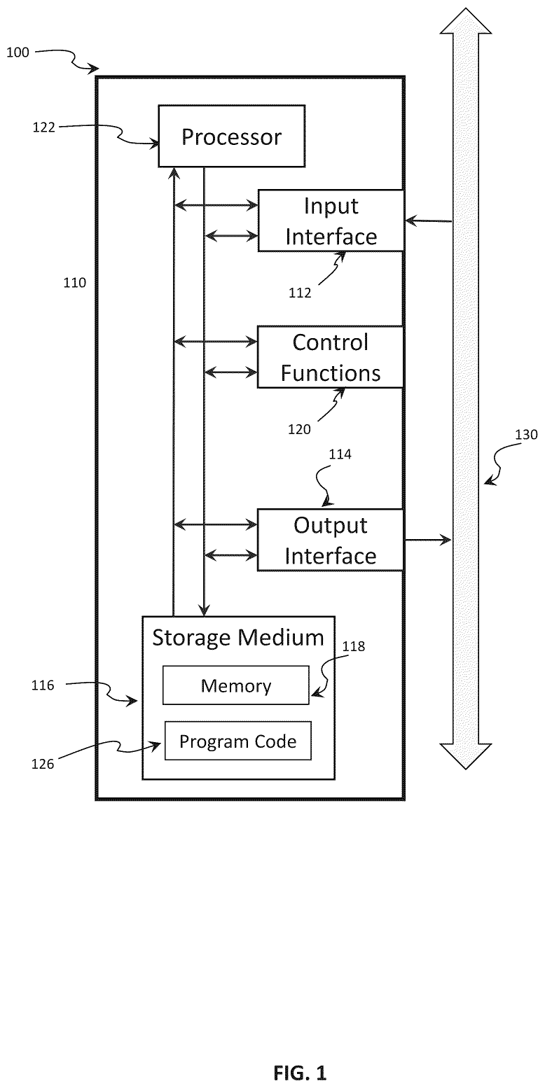

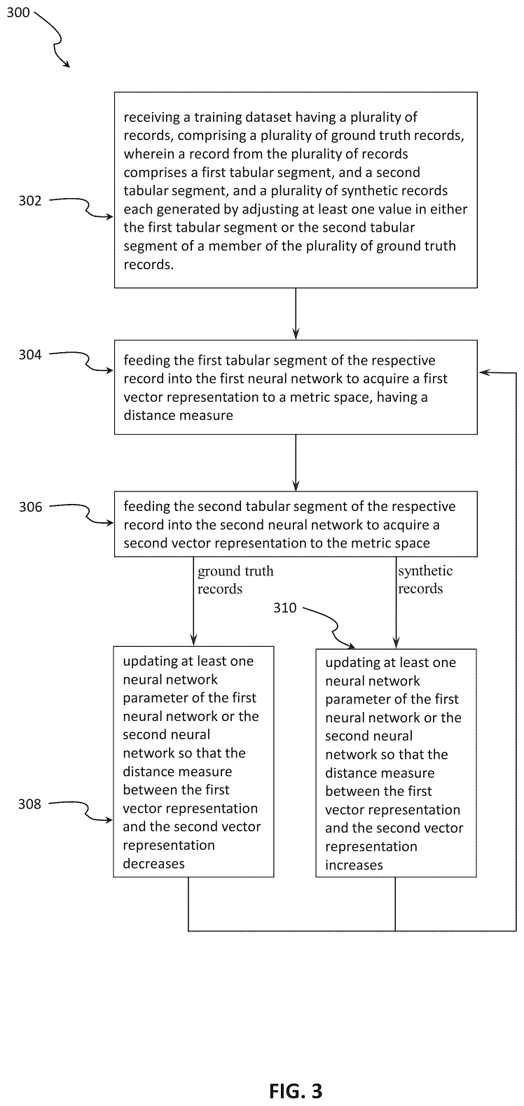

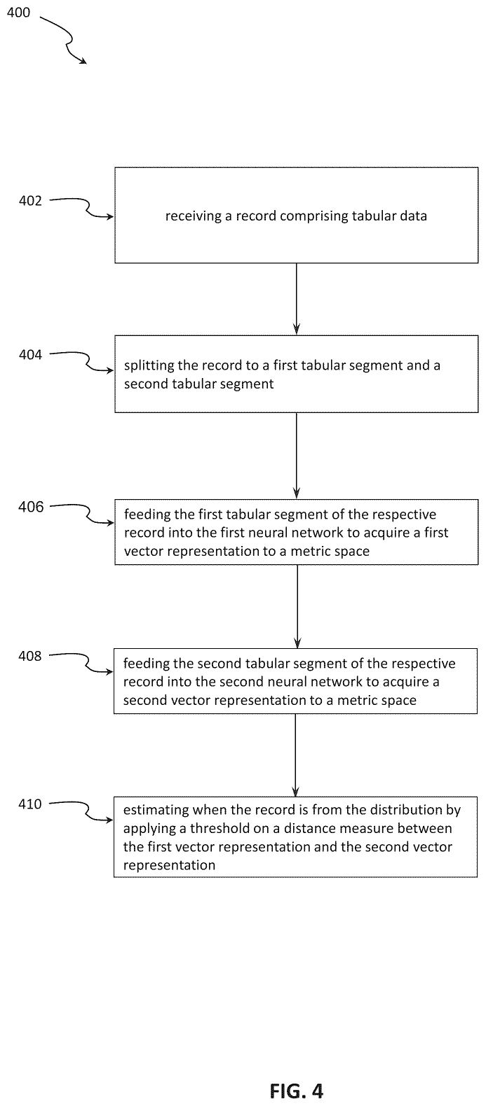

Referring now to the drawings, FIG. 1 is a schematic illustration of an exemplary system for anomaly detection and machine learning, according to some embodiments of the present disclosure. An exemplary anomaly detection and machine learning system 100 may execute processes such as 300 and/or 400 for raining a system for inference from data records using anomaly detection, and/or using the system for inference respectively. Further details about these exemplary processes follow as FIG. 3 and FIG. 4 are described.

The anomaly detection and machine learning system 110 may include a network interface, which comprises an input interface 112, and an output interface 114. The anomaly detection and machine learning system may also comprise one or more processors 122 for executing processes such as 300 and/or 400, and storage 116, comprising a portion for storing code (program code storage 126) and/or memory 118 for data, such as network parameters, and records for training and/or inference. The anomaly detection and machine learning system may be physically located on a site, implemented on a mobile device, implemented as distributed system, implemented virtually on a cloud service, on machines also used for other functions, and/or by several options. Alternatively, the system, or parts thereof, may be implemented on dedicated hardware, FPGA and/or the likes. Further alternatively, the system, or parts thereof, may be implemented on a server, a computer farm, the cloud, and/or the likes. For example, the storage 116 may comprise a local cache on the device, and some of the less frequently used data and code parts may be stored remotely.

The input interface 112, and the output interface 114 may comprise one or more wired and/or wireless network interfaces for connecting to one or more networks, for example, a local area network (LAN), a wide area network (WAN), a metropolitan area network (MAN), a cellular network, the internet, a combination thereof, and/or the like. The input interface 112, and the output interface 114 may further include one or more wired and/or wireless interconnection interfaces, for example, a universal serial bus (USB) interface, a serial port, and/or the like. Furthermore, the output interface 114 may include one or more wireless interfaces for presenting analytics, generating alerts, operating a medical device, and the input interface 112, may include one or more wireless interfaces for receiving information such as data records or configuration from one or more devices. Additionally, the input interface 112 may include specific means for communication with one or more sensor devices such as a camera, microphone, medical sensor, weather sensor and/or the like. And similarly, the output interface 114 may include specific means for communication with one or more display devices such as a loudspeaker, display and/or the like.

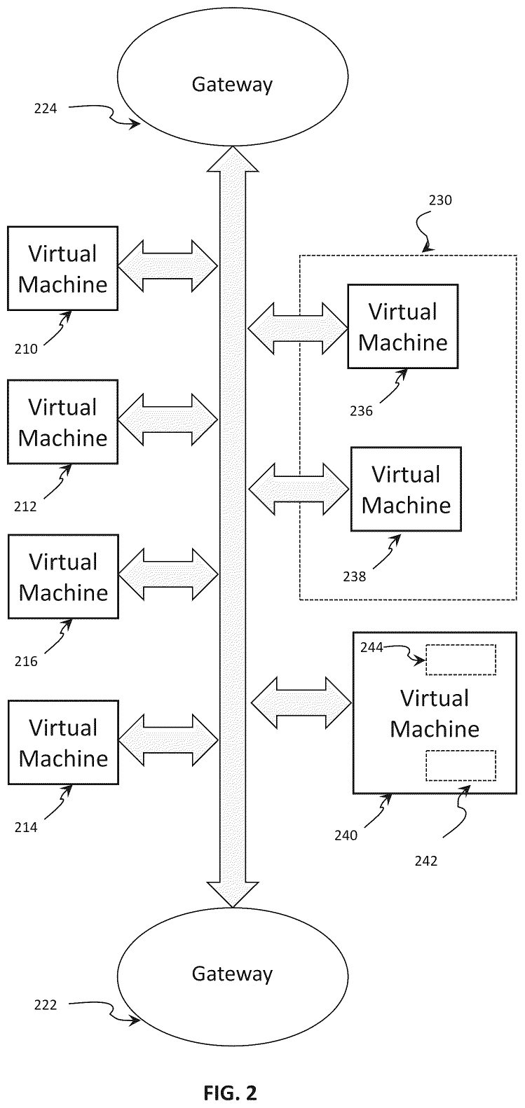

Both parts of the processing, storage and delivery of data records, and inference result processing may be executed using one more optional neighbor systems as described in FIG. 2.

The one or more processors 122, homogenous or heterogeneous, may include one or more processing nodes arranged for parallel processing, as clusters and/or as one or more multi core one or more processors. Furthermore, the processor may comprise units optimized for deep learning such as Graphic Processing Units (GPU). The storage 116 may include one or more non-transitory persistent storage devices, for example, a hard drive, a Flash array and/or the like. The storage 116 may also include one or more volatile memory devices, for example, a random access memory (RAM) component, enhanced bandwidth memory such as video RAM (VRAM), and/or the like. The storage 116 may further include one or more network storage resources, for example, a storage server, a network attached storage (NAS), a network drive, and/or the like accessible via one or more networks through the input interface 112, and the output interface 114.

The one or more processors 122 may execute one or more software modules such as, for example, a process, a script, an application, an agent, a utility, a tool, an operating system (OS) and/or the like each comprising a plurality of program instructions stored in a non-transitory medium within the program code 114, which may reside on the storage medium 116. For example, the one or more processors 122 may execute a process, comprising inference or training of a system for or using anomaly detection and machine learning such as 300, 400 and/or the like. This processor may generate inferences such as classification, object detection, anomaly detection, segmentation and/or the like. Furthermore, the processor may execute one or more software modules for online or offline training of one or more types of machine learning models, as well as auxiliary models.

Referring now to, FIG. 2 which is a schematic illustration of an exemplary distributed system for anomaly detection and machine learning, according to some embodiments of the present disclosure.

The network may be used for anomaly detection and machine learning, and labelled as a LAN, WAN, a cloud service, a network and/or the like. The network may allow communication with virtual machines functioning as computing nodes, as shown in 210, 212, 214, 216, 236, 238 and 240. The correspondence between virtual machines and physical machines may be of any positive rational number. For example, the physical machine shown in 230 hosts both virtual machines 236 and 238, however, the virtual machine 240 is implemented by both physical machines 242 and 244.

The network may interface the outside network, e.g. the internet, through gateways such as 224 and 222. Gateways may comprise features such as routing, security, load management, billing, and/or the like however some, or all of these features may also be otherwise handled by other machines in or outside the network.

Referring now to FIG. 3, which is a flowchart of an exemplary process for training a machine learning model using anomaly detection, according to some embodiments of the present disclosure. The processor 122 may execute the exemplary process 300 for training a machine learning model for a variety of purposes where at least part of the data is tabular, including biomedical, business analytics, cyber security, and/or the like. Alternatively, the process 300 or parts thereof may be executing using a remote system, an auxiliary system, and/or the like.

The exemplary process 300 starts, as shown in 302, with receiving a training dataset having a plurality of records, comprising a plurality of ground truth records, wherein a record from the plurality of records comprises a first tabular segment, and a second tabular segment, and a plurality of synthetic records each generated by adjusting at least one value in either the first tabular segment or the second tabular segment of a member of the plurality of ground truth records.

The plurality of ground truth records may be taken from a dataset, collected from various sources which are considered reliable. Optionally or alternatively, the plurality of ground truth records may be scanned and cleaned from outliers.

The adjusting of at least one value may be done by modifying some of the values, selecting different values, exchanging between values of the same kind, e.g. categorical or numerical, rotating a vector, and/or the like.

The exemplary process 300 continues, as shown in 304, with feeding the first tabular segment of the respective record into the first neural network to acquire a first vector representation to a metric space, having a distance measure. The vector representations may also be referred to as embeddings, and for the purpose of this disclosure, scalars, complex numbers, lists, matrices, tensors, and the likes may be considered as vectors. The neural network used in the experiment shown is fully connected, however other architectures such as convolutional neural networks, recurrent neural networks, networks having adjustable receptive fields, and other types of machine learning models such as random fields or the likes.

The exemplary process 300 continues, as shown in 306, with feeding the second tabular segment of the respective record into the second neural network to acquire a second vector representation to the metric space. Similarly to 304, the second tabular segment, representing the rest of the vector, may be processed by a similar machine learning model to map the second tabular segment to the same, or a compatible metrics space. Some alternative implementations may use different types of machine learning models, however the model used for the experiments used networks whose architecture differ in width due to the different sizes of the first and the second tabular segment.

When the record is one of the plurality of ground truth records The exemplary process 300 continues, as shown in 308, with updating at least one neural network parameter of the first neural network or the second neural network so that the distance measure between the first vector representation and the second vector representation decreases. Stochastic gradient descent, as well as adaptive and optimized methods may be used to update the parameters. The updating may be based on optimizing a loss function formulated to prefer short distance between the representations of segments of ground truth records. Some or all the model parameters may be adjusted in each step.

When the record is one of the plurality of synthetic records The exemplary process 300 continues, as shown in 310, with updating at least one neural network parameter of the first neural network or the second neural network so that the distance measure between the first vector representation and the second vector representation increases. The updating may be based on optimizing a loss function formulated to prefer long distance between the representations of segments of synthetic records. This updating, together with 308, may be referred to as contrastive learning.

And optionally, as shown in 308, the process 300 may repeat by executed additional interactions of by using one or more processors 122, for processing one or more of the plurality of records. Since steps 304, 306, 308 and 310 explain a single iteration, the training process may take a plurality of iterations, and the steps may be repeated.

Reference is also made to FIG. 4, which is a basic flow chart of an exemplary inference process by a machine learning model trained using anomaly detection, according to some embodiments of the present disclosure.

The exemplary process 400 may be executed for executing one or more automatic and/or semi-automatic inference tasks, for example analytics, surveillance, security, maintenance, medical monitoring and/or the like. The process 300 may be executed by the one or more processors 122.

The process 400 may start, as shown in 402 by receiving a record comprising tabular data through the input interface 112. The record may comprise tabular data, such as numerical and categorical data. The records may also comprise text, which may be processed by methods such as embedding, encoding such as one hot, or directly. In some examples, these records may also comprise other kinds of data such as images and sound samples. The records may be generated or collected online, through communication or directly from measuring instrument or input devices, or be taken from a repository, a dataset, and the like.

The exemplary process 400 continues, as shown in 404, with splitting the record to a first tabular segment and a second tabular segment. The splitting may be done in the same manner applied in the training. Some embodiments may use a fixed splitting, while other may have several splitting, and make the inference decision using the highest confidence obtained, a majority voting, a weighted average4, and/or the like.

The exemplary process 400 continues, as shown in 406, with feeding the first tabular segment of the respective record into the first neural network to acquire a first vector representation to a metric space. The neural network, or alternatively a machine learning model of a different type, may map the data record to a scalar or a vector space, for example a Euclidean space.

The exemplary process 400 continues, as shown in 408, with feeding the second tabular segment of the respective record into the second neural network to acquire a second vector representation to a metric space. Similarly to 406, the second neural network, or other machine learning model may map the second tabular part to a space compatible with the scalar or vector space of 406.

The exemplary process 400 continues, as shown in 410, with estimating when the record is from the distribution by applying a threshold on a distance measure between the first vector representation and the second vector representation. The inference may be made by comparing the distance measure between the mappings or embeddings of the two former stages 406 and 408 to a threshold, so that a short distance indicates belonging to the class, and a longer distance indicates that the record is not from the distribution. Some embodiments may use a plurality of thresholds or a continuous measure to indicate confidence level, and possibly perform further analysis when the confidence is insufficient.

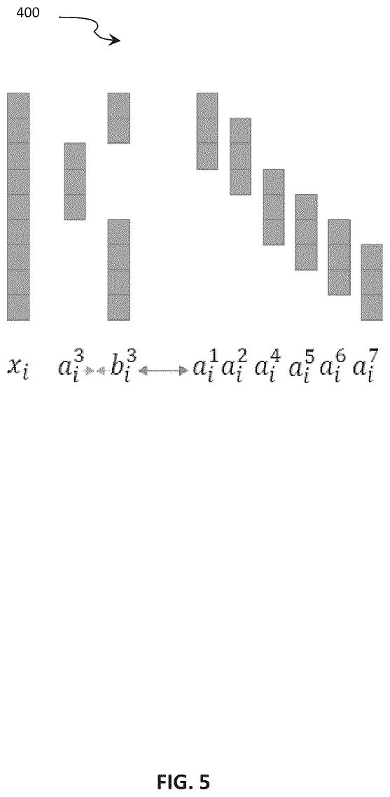

Referring now to FIG. 5 which is a schematic graph representing an exemplary partition of an exemplary vector used for contrastive learning, according to some embodiments of the present disclosure.

Some embodiments of the disclosure may maximize the mutual information through the use of the noise contrastive estimation framework as illustrated in FIG. 5, using contrastive relations. In this framework, there is a query q, a positive sample v⁺, and negative ones v⁻, all vectors in R^{u}. Contrastive learning is based on maximizes the similarity of the query with the positive sample, while minimizing it with the negative samples.

Given a sample data record, a vector xᵢ, the disclosure considers the short vector of consecutive values a³ᵢ and the complementary vector b³ᵢ. The networks are trained to produce similar embeddings for this pair of vectors which is a ground truth record, while distancing the embedding of aᵢ^{j′} for j′≠3, which are synthetic records, having at least one element permuted from the first tabular segment to the second tabular segment, from that of b³ᵢ.

The vectors are given, for some i,j,j′≠j as:

$$\begin{matrix}ℒ = {\sum }_{x ∈ s} y ( x ) \\ {v}^{+} \\ = G ( {a}_{j}^{i} ) \\ {v}^{-} \\ = G ( {a}_{i}^{{j}^{′}} )\end{matrix}$$

Almost all current contrastive learning methods employ normalization of the vectors q and v⁺, v⁻ such that their unit norm is 1. This normalization may be performed after a first normalization step that may be applied at each vector dimension in R^{u} separately, by considering all of the sub-vectors of the input vector xᵢ, thereby applying normalization to at least one element of the tabular data.

The normalized network F^{N} may consider the u×m matrix B=[F(bᵢ¹), F(bᵢ²), . . . , F(bᵢ^{m})] and normalizes each row of it to have a L2 norm of 1 to obtain a matrix B^{N}. The disclosure may define the normalized network F^{N} such that F^{N} (bᵢ^{j}) is the j-th column B^{N}, further normalized to an L2-norm of one. Although omitted it from the operand list, F^{N}(bᵢ^{j}) depends not only on b^{j}ᵢ but on all of the b-type vectors in φ(xᵢ). Similarly, G^{N}(aᵢ^{j}) is defined by considering the matrix A^{N}, which may be a double normalized version of the matrix that contains all vectors of the form G(aᵢ^{j}), where j varies by column.

The contrsastive loss l may be defined as an m-way classification problem, in which the cross entropy loss for a given temperature r is used. The logit used is the pseudo-probability for the positive sample v⁺ being selected over m−1 negatives given the query q. Note that the normalized versions of these vectors are being used:

$$ℓ ( F , G , ϕ ( {x}_{i} ) , j ) = - ln \frac{exp ( {F}^{N} ( {b}_{i}^{j} ) \cdot {G}^{N} ( {a}_{i}^{j} ) / τ )}{{\sum }_{\hat{j} = 1}^{m} exp ( {F}^{N} ( {b}_{i}^{j} ) \cdot {G}^{N} ( {a}_{i}^{\hat{j}} ) / τ )}$$

Once the networks F and G are trained with the contrastive loss, the disclosure may define the one-class classification score as:

$$y ( x ) = {\sum }_{j} ℓ ( F , G , ϕ ( x ) , j ) ,$$

where φ(x) is constructed for sample x similar to the construction of φ(xᵢ) for training sample xᵢ.

By applying this exemplary loss, at least one neural network parameter of the first neural network or the second neural network is updated so that the distance measure between the first vector representation and the second vector representation decreases when the record is one of the plurality of ground truth records, and the distance measure between the first vector representation and the second vector representation increases when the record is one of the plurality of synthetic records. Alternative ways of defining a contrastive loss function, or other loss functions for obtaining functionally equivalent embeddings are apparent to the person skilled in the art.

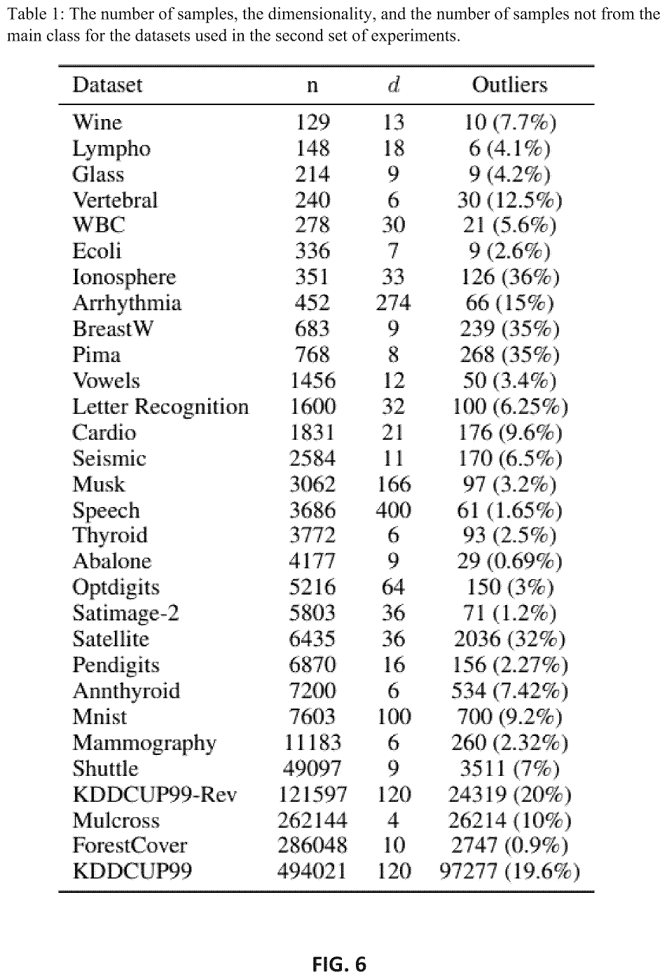

Referring now to FIG. 6 which is a table, showing the number of samples, the dimensionality, and the number of samples not from the main class in datasets used for an experiment, according to some embodiments of the present disclosure.

Given a training set S, the overall training loss may contain only one type of loss and may be defined as:

$$ℒ = {\sum }_{x ∈ s} y ( x )$$

The exemplary training used for the experiment employs the Adam optimizer with a learning rate of 10⁻³. It stops when the loss is smaller than 10⁻³ for datasets with d<40. For datasets with a larger input dimension, this stopping criterion would lead to long training sessions, and a relaxed convergence threshold of 0.01 may be used.

The parameter u was fixed at 200, regardless of the dimensionality of the problem. k needs to be set proportionally to the input dimension d. For d smaller than 40, the exemplary training used k=2, for d in the range [40, 160] and employs k=10, and for d>160, k takes the value d−150. Therefore, for most examples, first tabular segment b is larger than the second tabular segment a.

When the number of features d is small, m=d−k+1 may be small and the network may be less informative. This problem becomes worse when the number of samples n is also small. In such a case, fitting u=200 may lead to overfitting.

Instead of changing the hyperparameters, it is possible to make use of the fact that the features are unordered and simply combine multiple scores, each obtained on a different permutation of the features. In the disclosed experiments, repeating this way is only very seldom detrimental to accuracy, and it improves performance for small d and very small n. On the other hand, it does add to the overall runtime.

In order to make use of this bagging effect, when needed, the number of repeats may be r=1+└100(log(n)+d)⁻¹┘. For each repeat after the first, the disclosure may randomly permute the set of features. The score that the method returns may be the mean of the scores obtained from each such repeat. The adjusting of the values in the synthetic records may comprises permuting element from the first tabular segment to the second tabular segment. Furthermore, applying at least one permutation to both the first tabular segment and the second tabular segment of record from the plurality of records may be used as augmentation for the training.

In the experiments shown, F and G are two fully connected networks with LeakyRELU activations using a slope coefficient of 0.2 in all layers of the plurality of layers, except for the first layer of F, which may have a tanh activation. Other types of machine learning models may produce different results. It is preferred to distance the embedding of the a-part of x and its b part, making a simple matching between the parts, which overlap for bᵢ^{j} and aᵢ^{j′} when j⁰6=j, ore challenging. This is an example of a network having a first layer and additional layers, and the activation of the first layer differs from the activation of at least one of the additional layers.

F may have two hidden layers, with u and 2u hidden units, each followed by Batch Normalization. G as in this experiment is similar, only that due to the smaller input sizes, the hidden layers have u/4 and u/2 units and Batch Normalization is applied only after the first layer. While both the first neural network and the second neural network used in the experiment were substantially fully connected neural networks, connections may be omitted, for example by adding layers, forming graphs having an adequate level of expansion, representing knowledge about the distribution in the network graph shape, and other methods known to the person skilled in the art. Furthermore, both the first neural network and the second neural network may comprises any number of layers, for example 2, 10, or 200, and one or more layers of the neural networks may be followed by batch normalization.

Datasets Borrowing the terminology of the field of anomaly detection were used, and the term “normal” to refers to the class observed during training, and abnormal to describe samples from the other class or classes. The experiments were conducted on two groups of datasets: (i) a collection of four datasets that are commonly used to report anomaly detection for tabular data, (ii) a much more comprehensive set of tabular datasets for benchmarking outlier detection.

The first set of datasets contains two small-scale medical datasets (Arrhythmia and Thyroid), as well as two cyber intrusion detection datasets (KDD and KDDRev) that are considerably larger. The categorical attributes are presented to the network as one-hot vectors.

The second set employs the “Multi-dimensional point datasets” from the Outlier Detection DataSets (ODDS) as accessed on January 2021 at www(dot)odds(dot)cs(dot)stonybrook(dot)edu/ It contains 31 datasets, including two of the four datasets above, as in the table in FIG. 6. Out of these datasets, the processing of the data of Heart, which is in a different format, did not finish in time for submission, and the link to Mulcross was broken. E coli and Yeast, for which it was not clear from the description which class is the normal one were omitted.

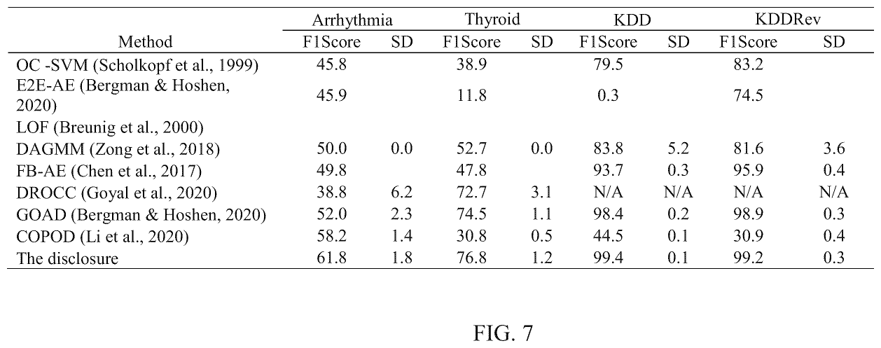

Referring now to FIG. 7 which is a table, showing experiment results, using some embodiments of the present disclosure.

Anomaly detection on the four datasets commonly used in the literature was performed in this experiment. Shown are mean F1 (percent) and standard deviation (SD) over multiple resampling. DROCC is reported based on the disclosed runs due to protocol discrepancies in the published code, some experiments are missing due to limitations of the published code.

Evaluation protocol and scores were applied, as the training set used for the experiment contains a random subset of 50% of the normal data. The test set contains the rest of the normal data, as well as all the anomalies. In the first set of experiments, the mean and standard deviation (SD) of the F1 score are reported. The experiments was computed over 500 random splits for the smaller datasets (Arrhythmia and Thyroid) and 10 splits for the larger ones (KDD and KDD-Rev). For the baseline methods, the sample size varies and in some cases the results reported in the literature are given without SD. Following the existing protocol, the decision threshold for scoring the methods was chosen such that the number of test samples above this threshold (i.e., classified as anomalies) is the number of anomalies in the test set.

For the second set of experiments, in addition to F1, the AUC. Since AUC varies less dramatically than F1 scores, it may be more suitable for comparing across datasets. It also may have the advantage that it does not require setting a threshold.

Baseline methods For the first set of experiments, a comprehensive set of literature baselines is presented. OneClass support vector machine (OC-SVM), the Deep Autoencoding Gaussian Mixture Model (DAGMM) method, and an End-to-End Autoencoder (E2E-AE) are reported as computed by Zong et al. (2018). GOAD as disclosed by Bergman & Hoshen, in 2020 (“Classification-Based Anomaly Detection for General Data) Local Outlier Factor, and an ensemble method (FB-AE) that employs autoencoders as the base classifier, feature bagging as the source of randomization, and reconstruction error as the anomaly score, are as reported in the publication. A recent baseline, Deep Robust One-Class Classification (DROCC), was rerun based on their code, since the published results sampled the test set using a different protocol. Finally, included the Copula-Based Outlier Detection (COPOD) baseline, based on the disclosed runs, as a modern non-deep-learning method.

The second set of experiments, was focused on the most recent methods: COPOD, GOAD and DROCC. Since GOAD uses three different architectures in their code, results are reported for all three. The first architecture is the one used for the small datasets, the second is used for KDD, and the third is the one used for KDDrev. Similarly, DROCC employs three architectures in their code: one for Thyroid, one for Arrhythmia, and one of Abalone, and all three were run. The disclosed method employs the same architecture in all experiments, except that k is adjusted according to d.

The results for the first set of experiments are reported in the table in FIG. 7. The disclosed method outperforms the literature baselines by a significant margin on Arrhythmia and Thyroid, where the baselines obtain a moderate F1 score. On the larger datasets, KDD and KDDRev, where the performance of GOAD is very high, the disclosure outperform it and obtain a near-perfect score. Out of the baseline methods, the feature bagging auto encoder (FB-AE) and GOAD seem to be the strongest and DROCC, with the correct protocol, is not as competitive. COPOD, despite being shown to be successful on many other benchmarks, does not perform particularly well on this first set

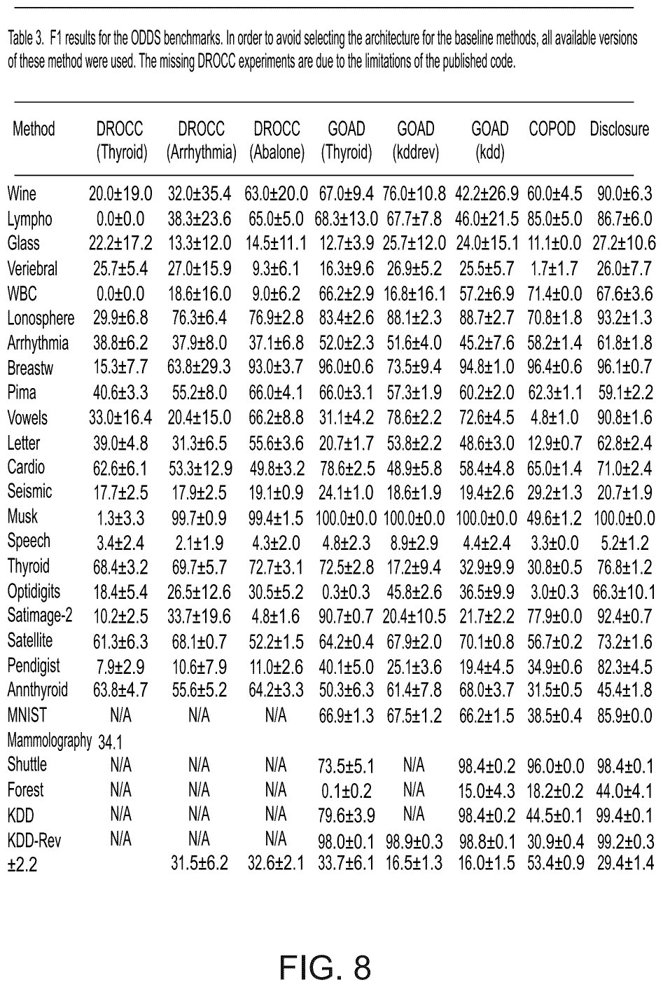

Referring now to FIG. 8 which is an additional table, showing additional experiment results, using some embodiments of the present disclosure.

The results for the second set of experiments are obtained by the disclosed runs and compared with GOAD and DROCC, each with three different architectures, as well as with COPOD. The latter has been shown to be highly effective on the ODDS collection, when tested with a random 60%/40% train/test split protocol.

The mean and SD for the F1 score across 20 runs are reported in the table shown in FIG. 8, and exemplary AUC results may be referred. As may be seen, in the vast majority of the cases (18), the disclosed method obtains the highest performance. COPOD has four datasets where it is leading over all other methods, and GOAD (when taking the max over all versions) leads on 5 datasets. DROCC is less competitive.

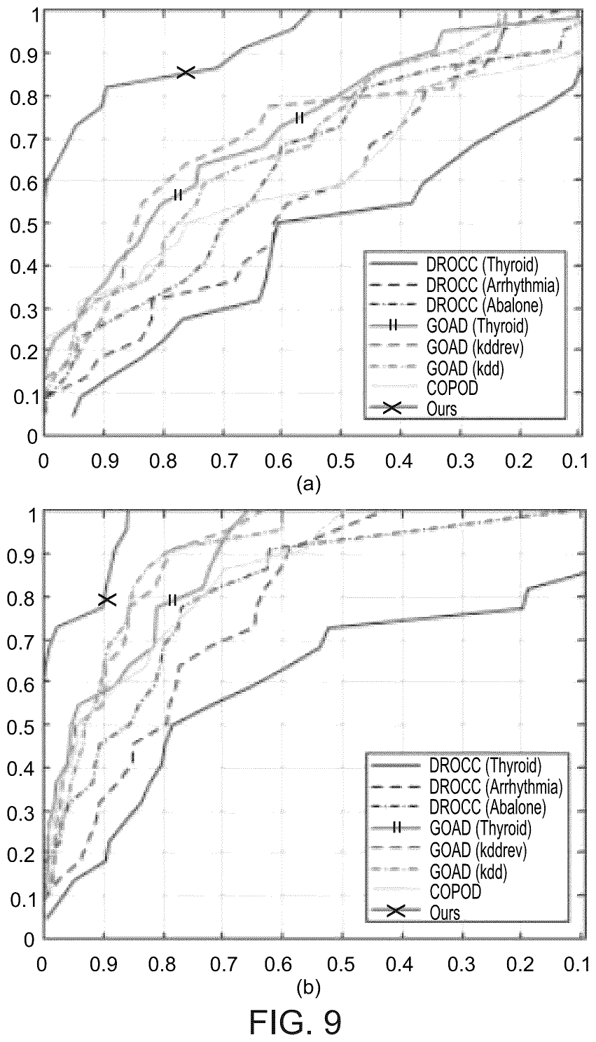

Referring now to FIG. 9 which is two graphs, showing Dolan-More profile for the ODDS experiments with F1 scores and area under the curve (AUC), according to experiment results, using some embodiments of the present disclosure.

To further visualize these multiple-benchmark results, a Dolan-More profile was used. In such profiles, there is a single plot per method. To obtain this plot, the ratio of benchmarks for which the method obtains up to a fraction θ of the maximal score obtained by all methods was considered. This is plotted for 0≤θ≤1 and a leading method would obtain a ratio of 1.0 closer to θ=1.

FIG. 9(a) presents the disclosure's results for the F1 score, showing that the disclosed method leads by a significant margin over the seven other alternatives. Since comparing F1 scores by a multiplicative factor may not be ideal, this experiment was repeated for the AUC score, reporting results in FIG. 9(b). In this case as well, the disclosed method is shown to have a very clear advantage over the baseline methods.

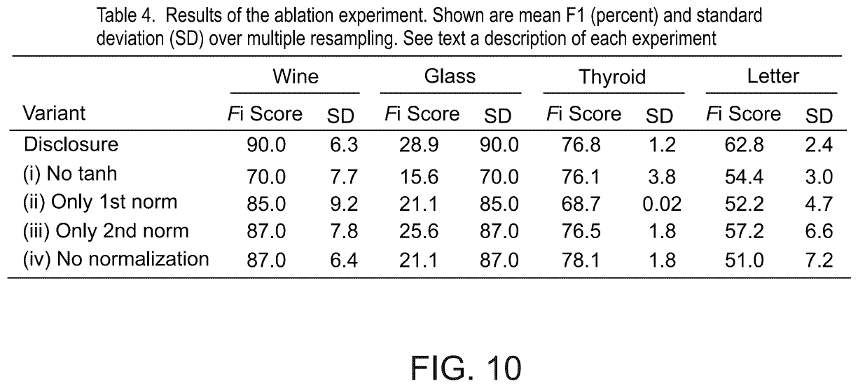

Referring now to FIG. 10 which is a table, showing results of an exemplary ablation experiment using some embodiments of the present disclosure.

The table in FIG. 10 shows results of the exemplary ablation experiment performed. Shown are mean F1 (percent) and standard deviation (SD) over multiple resampling. See text for a description of each experiment.

The experiment used four representative datasets (‘Wine’, ‘Glass’, ‘Thyroid, ‘Letter’) that vary in the number of dimensions, the number of samples, and the performance level, and run an ablation analysis on these. The variants compared include: (i) a variant of the disclosed method in which the tanh activation of the first layer of F is replaced by a LeakyRELU, (ii) a variant in which only the first one out of the two normalizations of the query and vectors that F and G output takes place (iii) a variant in which only the second normalization takes place, i.e, normalization occurs in the conventional way, and (iv) a variant in which no normalization takes place, i.e., F,G are trained and used instead of F^{N} and GN.

The results are reported in the table in FIG. 10. As may be seen, the tanh activation for the first hidden layer of F improves results, to a varying degree, on the four datasets. The normalization tends to help across datasets. However, on Thyroid, applying no normalization at all provides better results. The person skilled in the art may also applied activations such as RELU, sigmoid. SoftPlus and the like. The both first neural network and the second neural network may have a first layer and additional layers and the activation of the first may layer differ from the activation of at least one of the additional layers due to various considerations, for example normalization and properties of the distribution.

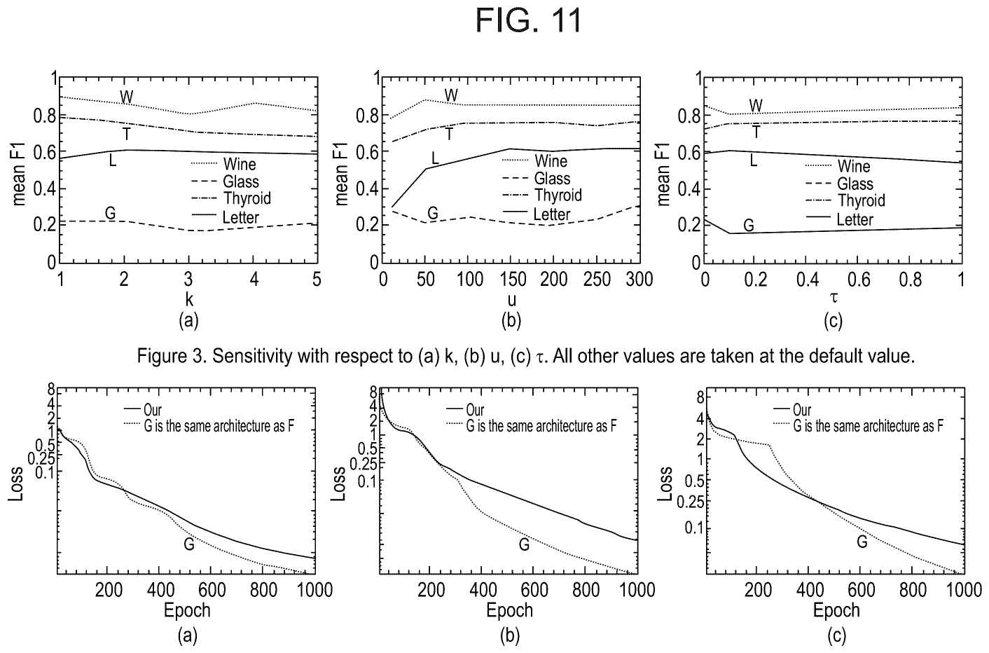

Referring now to FIG. 11 which is a set of graphs, showing experiment results of parameter sensitivity and convergence of the loss on random data, according to some embodiments of the present disclosure.

The figure shows sensitivity with respect to the upper row (a) k, (b) u, (c) τ. where other values are taken at the default value, and convergence of the loss on completely random data, to evaluate the ability to perform class independent learning in the lower row. (a) d=6 (b) d=15. (c) d=30.

On the same four datasets, the sensitivity of the method to its hyperparameters was also evaluated: k, u, and τ, in each experiment, fixing two parameters and vary the third. The results, shown in FIG. 11's upper row, indicate that the method is largely insensitive to its parameters. This robustness is further supported by using the same hyperparameters on a large number of datasets.

The self-supervised task may be solved through the learning of the mappings F and G which may be relatively simple and may be solved without learning in O(dm), since it amounts to identifying whether b^{j}ᵢ and a^{j0}ᵢ overlap, in which case j⁰6=j or not, which implies that j⁰=j. Since this decision process is not class-specific, the learned representations seem to be very distinctive of the class membership may be surprising.

Consider by way of analogy the self-supervised learning of natural image by employing a contrastive loss between an anchor image, its transformation, and another image. Identifying the transformation between two images, which is not harder than finding whether they are related by a transformation, may be done reliably with neural networks using point matching, or using “direct methods”. These methods are not class-specific. However, the representations learned by applying geometric transformations are extremely distinctive of the class.

In order to study this further, a random data experiment, in which the vectors x are composed of d independent variables sampled uniformly in [−1,1] was designed. Followingly, learning the networks F and G and observe the success in identifying index j, vs. the other indices. The results for d=6, 15, 30 are reported in FIG. 11's lower row. As may be seen in the disclosed method experiments, the loss is being reduced while training. However, the network is not able to immediately obtain perfect performance, especially for larger d.

The architectures of F and G may differ based on the motivation that this would possibly make the class independent solution less accessible during training. As shown in FIG. 4, when replacing the architecture of G to be identical to that of F, the class-independent learning may have a lower error on most epochs.

It has been argued that tabular data tends to have considerably more structural variance between datasets than perceptual data. The type of features, for example continuous or categorical, the number of features, and the dependencies between the features greatly vary from one dataset to the next. This variance makes the development of a generic anomaly detection method challenging, and a significant difference in performance for all methods was observed.

Note, however, that the disclosed method is more stable than the recent methods, and is able to handle multiple datasets using the same architecture, except for a minimal tuning that is directly related to the dimensionality of the data. For example, on the four datasets commonly used in the literature, the method is applied exactly the same, except for Thyroid, where due to the low input dimensionality (d=6), the value of k=2 was used. This is another example wherein the first tabular segment is larger than the second tabular segment. In contrast, GOAD, for example, has multiple stopping criteria, depending on the dataset (early stopping or 25 epochs) and employs three architectures on four datasets.

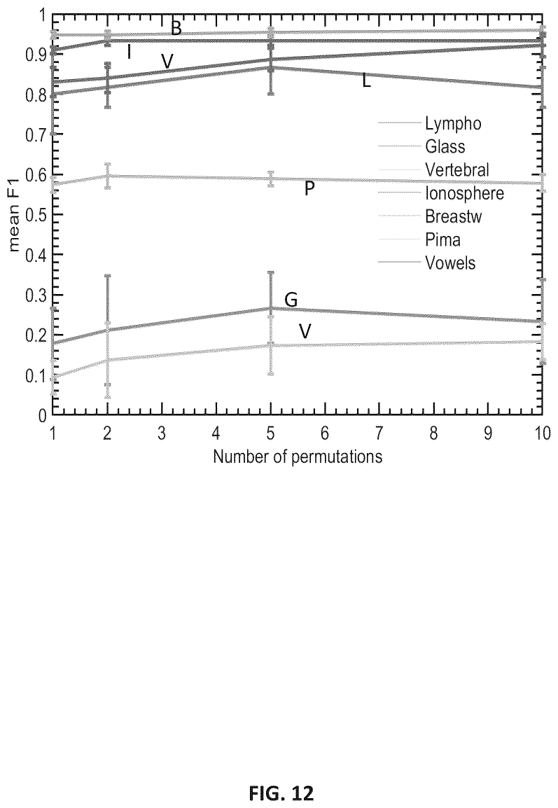

Referring now to FIG. 12 which is a graph, showing experiment results of effects of the number of repeats on F1 scores, according to some embodiments of the present disclosure.

The score may be computed multiple times after permuting the features, and the number of repeats (r) depends on the dimensionality d and number for samples n. FIG. 12, presents the effect of the number of repeats on the performance for multiple relatively small datasets, at different performance levels. Shown are the mean AUC over 10 runs and also, as error bars, the SD.

It was observed that adding repeats typically helps, albeit in a modest way. It also tends to reduce the variance between runs. A drop in performance between the first and the second repeat may indicate that the order of features is informative. However, this does not happen often.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant machine learning models will be developed and the scopes of the terms machine learning model. and training are intended to include all such new technologies a priori.

The terms “comprises”, “comprising”, “includes”, “including”, “having” and their conjugates mean “including but not limited to”. This term encompasses the terms “consisting of” and “consisting essentially of”.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment may include a plurality of “optional” features unless such features conflict.

Throughout this application, various embodiments may be presented in a range format. It should be understood that the description in range format is merely for convenience and brevity and should not be construed as an inflexible limitation on the scope of embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of embodiments, which are, for clarity, described in the context of separate embodiments, may also be provided in combination in a single embodiment. Conversely, various features of embodiments, which are, for brevity, described in the context of a single embodiment, may also be provided separately or in any suitable subcombination or as suitable in any other described embodiment. Certain features described in the context of various embodiments are not to be considered essential features of those embodiments, unless the embodiment is inoperative without those elements.

Although embodiments have been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicants that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A method of training a model for inferring when a record is from a distribution, using a model comprising a first neural network and a second neural network, the method comprising:
receiving a training dataset having:
a plurality of records comprising a plurality of ground truth records, wherein a record from the plurality of records comprises a first tabular segment, and a second tabular segment;
a plurality of synthetic records each generated by adjusting at least one value in either the first tabular segment or the second tabular segment of a member of the plurality of ground truth records; and
in each of a plurality of iterations processing one of the plurality of records by:
feeding the first tabular segment of the respective record into the first neural network to acquire a first vector representation to a metric space, having a distance measure;
feeding the second tabular segment of the respective record into the second neural network to acquire a second vector representation to the metric space;
when the record is one of the plurality of ground truth records updating at least one neural network parameter of the first neural network or the second neural network so that the distance measure between the first vector representation and the second vector representation decreases; and
when the record is one of the plurality of synthetic records updating at least one neural network parameter of the first neural network or the second neural network so that the distance measure between the first vector representation and the second vector representation increases.

2. The method of claim 1, further comprising applying at least one permutation to at least one record from the plurality of records.

3. (canceled)

4. The method of claim 1 wherein the adjusting comprises permuting at least one element from the first tabular segment to the second tabular segment.

5. A method of inferring when a record is from a distribution using a model comprising a first neural network and a second neural network, comprising:
receiving a record comprising tabular data;
splitting the record to a first tabular segment and a second tabular segment;
feeding the first tabular segment of the respective record into the first neural network to acquire a first vector representation to a metric space;
feeding the second tabular segment of the respective record into the second neural network to acquire a second vector representation to a metric space; and
estimating when the record is from the distribution by applying a threshold on a distance measure between the first vector representation and the second vector representation.

6. The method of claim 5, wherein the first tabular segment is larger than the second tabular segment.

7. The method of claim 5, wherein the first neural network is substantially a fully connected neural network.

8. The method of claim 5, wherein the second neural network is substantially a fully connected neural network.

9. The method of claim 7, wherein the first neural network comprises at least two layers, having a first layer and additional layers and the activation of the first layer differs from the activation of at least one of the additional layers.

10. The method of claim 5, further comprising applying normalization to at least one element of the tabular data.

11. The method of claim 5, applied on a plurality of dataset records, and further comprising training an additional network using a method assigning lesser weight to records for which the distance measure exceeded the threshold.

12. A system for inferring when a record is from a distribution using a model comprising a first neural network and a second neural network, comprising processing circuitry adapted for executing a code for:
receiving a record comprising tabular data;
splitting the record to a first tabular segment and a second tabular segment;
feeding the first tabular segment of the respective record into the first neural network to acquire a first vector representation to a metric space;
feeding the second tabular segment of the respective record into the second neural network to acquire a second vector representation to a metric space; and
estimating when the record is from the distribution by applying a threshold on a distance measure between the first vector representation and the second vector representation.

13. The system of claim 12, wherein the first tabular segment is larger than the second tabular segment.

14. The system of claim 12, wherein the first neural network is substantially a fully connected neural network.

15. The system of claim 12, wherein the second neural network is substantially a fully connected neural network.

16. The system of claim 14, wherein the first neural network comprises at least two layers, having a first layer and additional layers and the activation of the first layer differs from the activation of at least one of the additional layers.

17. The system of claim 12, further comprising applying normalization to at least one element of the tabular data.

18. The system of claim 12, wherein the processing circuitry is further adapted for executing a code for training an additional network using a method assigning lesser weight to records for which the distance measure exceeded the threshold.

19. (canceled)
